(19) United States
(12) Patent Application Publication
(10) Pub. No.: US 2009/0169969 A1
(43) Pub. Date: Jul. 2, 2009

(54) BIPOLAR PLATE OF SOLID OXIDE FUEL CELL

(75) Inventors: Shu-Feng Lee, Hsinchu (TW); Che-Wun Hong, Hsinchu (TW); Chin-Hsien Cheng, Hsinchu (TW)

Correspondence Address: ROGER H. CHU, 19499 ERIC DRIVE, SARATOGA, CA, 95070, US

(73) Assignee: NATIONAL TSING HUA UNIVERSITY (TAIWAN), Hsinchu (TW)

(21) Appl. No.: 12/340,913

(22) Filed: Dec. 22, 2008

(30) Foreign Application Priority Data
Dec. 27, 2007 (TW) 096150416

(51) Int. Cl. H01M 2/02

(52) U.S. Cl. 429/34

(57) ABSTRACT

This invention relates to a composite-material bipolar plate also known as an inter-connector of solid oxide fuel cell. The bipolar plate is constructed by a stamped sheet metal and two ceramic sealing materials as insulating grooves. The metal sheet is stamped to be with a corrugated shape, which is for collecting currents and for gas flow channels. The ceramic sealing materials as insulating grooves insolate anode and cathode electrodes and also block a leaking passage. The present invention can reduce thermal cracking conductivity and has the advantages of low cost, easy-to-make, high temperature resistance, high electric conductivity, and excellent sealing effect. In addition, the invention can shorten the start-up lag by externally preheating the metal sheet to heat up the fuel cell stack in a short period.

### BACKGROUND OF THE INVENTION

1. Field of the Invention

The present invention generally relates to a bipolar plate of a solid oxide fuel cell also known as an inter-connector of the solid oxide fuel cell, and more particularly to a bipolar plate installed in a solid oxide fuel cell stack for separating two adjacent fuel cells and having two reaction gas channels and a temperature adjustment function, and the bipolar plate is constructed by a metal sheet and two ceramic sealing materials as two insulating grooves, and the metal sheet acts as a medium for conducting current between two electrodes of the bipolar plate.

2. Description of the Related Art

In recent years, governments and private sectors of different countries invest tremendous manpower and capitals for the research and development of fuel cell technologies. Since fuel cells are energy converting devices with high efficiency and low pollution, and which anode supplies a fuel and whose cathode supplies an oxidizing agent, therefore chemical energy can be converted into electric energy by an electrochemical reaction directly. The solid oxide fuel cell conducts oxygen ions through a solid electrolyte for an electrochemical reaction to generate electric energy and has the advantages of a high energy conversion efficiency (60˜80%), a low discharge of polluted gases, and diversified applications of the fuel.

The preliminary objective of the research and development of solid oxide fuel cell systems is to supply electric energy for an electric generator in a power plant. In the development process of the solid oxide fuel cell systems, there are various different designs of cell stacks, and two of the common designs of solid oxide fuel cells are tubular and planar designs. The tubular design has a low output power density and can be used for a fixed electric generation device, and the planar design can provide approximate an output power density of 2 W/cm², but it is necessary to overcome two issues to achieve the practical applications of the planar solid oxide fuel cell. Firstly, it takes too long for the solid oxide fuel cell to reach a specific working temperature range. Secondly, a cell stack has two major problems, respectively metal fatigue and expansion crack when the solid oxide fuel cell is operated at a high temperature.

To overcome the issue of operating a cell stack at a high temperature for a long time, R.O.C. Patent Publication Nos. M281305 and M273828 disclose an improved design of using a channel structure of a connecting plate and a stopping block to overcome the cracking issue of a cell stack. Related technologies of passing a working fluid of the fuel cell into an electrochemical reaction zone uniformly and smoothly is adopted to achieve the electricity distribution of an electric substrate, so as to reduce the temperature difference. However, the new fluid structure formed by the stopping block goes through several times of a thermal cycle, the stress may be concentrated easily to damage the sealing of the cell stack, and thus resulting in a complicated manufacturing process. Obviously, the structural design of channels of this sort has no significant effect on the quick start of the fuel cell.

In addition, a composite electroplating method can be used as well, wherein yttrium stabilized zirconium (YSZ) oxide particles are added in a nickel electrolyte solution, and a solid oxide fuel cell anode is made of a porous material by an electroplating process, and the temperature of the electrolyte solution is controlled to make a flexible porous Ni-YSZ anode electrode film, such as the technology disclosed in R.O.C. Patent Publication No. I243216. This technology only improves the capability of resisting the thermal stress of an electrode plate to avoid inappropriate electric distribution that may cause a non-uniform thermal stress and a possible crack, but it still cannot prevent the non-uniform temperature distribution effectively and has no significant effect on the quick startup of the fuel cell. In general, the solid oxide fuel cell is operated at a temperature within a range of 400□˜1200□. If the temperature distribution of the cell is poor, the stress will be centralized easily to cause a low performance or even a failure. The planar solid oxide fuel cell tends to be developed with a low temperature mode around 400□˜800□, and the aforementioned prior art generally tends to develop fuel cells with new materials such as those disclosed in R.O.C. Patent Publication Nos. I243216, I253779, 200603474, and 00591814, and these prior arts attempt using different materials, structures or protecting films in order to extend the life of the cell stack, but seldom consider the research and development on a bipolar plate of the fuel cell. The present invention provides a bipolar plate having a reaction gas channel and a temperature adjusting function to overcome the issues of metal fatigue and expansion crack of the cell stack effectively and achieve a quick startup of the cell stack operated at a specific working temperature range. The inventor of the present invention based on years of experience in the related industry to conduct extensive researches and experiments, and finally developed a bipolar plate of a solid oxide fuel cell in accordance with the present invention to overcome the shortcomings of the prior art.

### SUMMARY OF THE INVENTION

At present, the bipolar plate (or inter-connector) of the solid oxide fuel cell still occupies a substantial percentage of the production cost of a fuel cell. If a bipolar plate with the uneasy-to-break, high temperature resisting, good conducting and excellent sealing effects can be manufactured with a lower production cost, then the price of a solid oxide fuel cell can be lowered and the life of the fuel cell can be extended to promote the popularity of a green electric generating device of the fuel cell and reduce the environmental pollution problem.

Therefore, the bipolar plate of the solid oxide fuel cell in accordance with the present invention is characterized in its shortening the start-up lag of the solid oxide fuel cell, reducing the occurrence of uneven thermal stresses of the solid oxide fuel cell stack, maintaining a good sealing effect and improving the life of the solid oxide fuel cell.

The present invention relates to a bipolar plate comprisinga metal sheet and a plurality of heat-resisting ceramic sealing materials as insulating grooves, and uses the stamped metal sheet as a metal framework with a corrugated shape The metal framework and the ceramic sealing materials as insulating grooves are combined to form a bipolar plate with an anode channel and a cathode channel and the function of adjusting the temperature. The bipolar plate has the advantages of low cost, easy-to-make, high temperature resistance, high electric conductivity, and excellent sealing effect for overcoming the disadvantages occurred in the fuel cell industry.

Therefore, another primary objective of the present invention is to provide a bipolar plate of a solid oxide fuel cell, and both sides of the bipolar plate have anode and cathode gas reaction zones respectively and two metal covers for adjusting temperature. The stamped metal covers are formed to be with corrugated shapes for serving as two seal covers above the gas reaction zones and disposed between two lateral sides of the metal sheet, the two external ends of the metal covers are interconnected to controllable heat sources, such that the fuel cell has the function of adjusting working temperature. Such bipolar plate with the temperature adjusting function can reduce possible cracks caused by the high temperature of the electrode plate.

Another objective of the present invention is to provide a bipolar plate of a solid oxide fuel cell, the stamped metal sheet of the bipolar plate with with the corrugated shape serves as a plurality of ribs in order to lower the manufacturing cost. The ribs are surrounded by ceramic sealing materials as insulating grooves for isolating each membrane electrode effectively, so that if a higher efficiency of the fuel cell is required, the number of membrane electrodes can be increased without a need of manufacturing a membrane electrode with a large area so as to lower the manufacturing cost of the membrane electrodes. In other words, if a membrane electrode in the cell stack is damaged, the failed membrane electrode can only be replaced so as to lower the cost of using the membrane electrodes.

A further objective of the present invention is to provide a bipolar plate of a solid oxide fuel cell, and the bipolar plate includes two stamped metal covers formed with corrugated shapes to serve as gas channels, so as to reduce the manufacturing cost. The gas channels are not directly connected to the membrane electrodes for reducing thermal stresses at the contact of the membrane electrodes. In addition, reducing the number of membrane electrodes may be effective, the invention can prevent possible crack caused by higher temperature. Since the external ends of the metal covers are interconnected to the heat sources, the invention can improve the startup problem of the solid oxide fuel cell to achieve the working temperature of the solid oxide fuel cell more uniformly and quickly.

Another objective of the present invention is to provide a bipolar plate of a solid oxide fuel cell, and the bipolar plate conducts current through two metal covers. The metal covers act as good conducting mediums and provide good isolation for the reaction gas between the anode and the cathode.

To make it easier for our examiner to understand the objectives, functions, and advantages of the present invention, preferred embodiments together with accompanied drawings are used for the detailed description of the invention as follows.

### BRIEF DESCRIPTION OF THE DRAWINGS

FIG. 1 is a planar schematic view of a preferred embodiment of the present invention;

FIG. 2 is a cross-sectional view of Section 21-21 as depicted in FIG. 1;

FIG. 3 is a perspective view of a metal framework in accordance with a preferred embodiment of the present invention; and

FIG. 4 is a cross-sectional view of Section 44-44 as depicted in FIG. 1.

### DETAILED DESCRIPTION OF THE PREFERRED EMBODIMENTS

In the present invention, the bipolar plate is divided into a central zone and a peripheral zone, and the central zone has a plurality of reaction gas blocks, and the peripheral zone has inlet and outlet channels through to the reaction gas channel of the central zone.

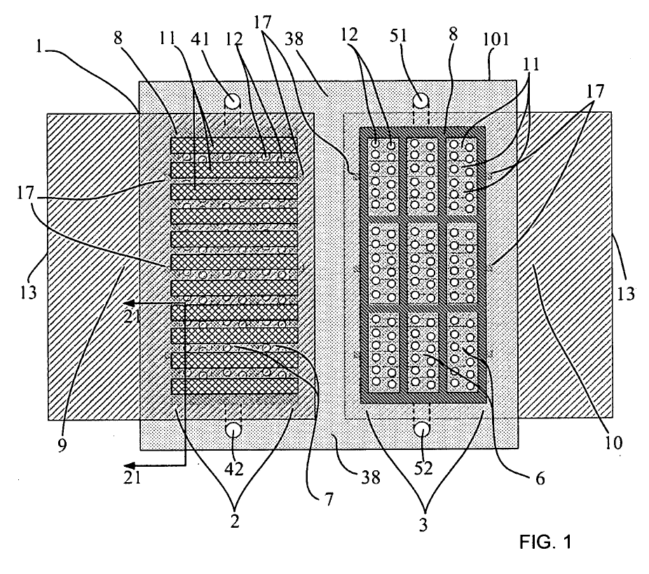

With reference to FIG. 1 for a planar schematic view of a bipolar plate 1 in accordance with a preferred embodiment of the present invention, a cathode reaction gas block 2 and an anode reaction gas block 3 required for transmitting a reaction gas of a fuel cell are disposed on both surfaces of a metal framework 101. In FIG. 1, oxygen channel inlet and outlet 41 and 42 for supplying oxygen to an anode and gas inlet and outlet 51 and 52 of a hydragen flow channel of an anode are the two reaction gas blocks 2 and 3, which are in two long strip portions, the long strip portions are provided for the bipolar plate 1 contacting to electrodes and have a plurality of current conducting ribs. In FIG. 1, the anode ribs 6 are shown on the top layer of FIG. 1, and the shadow cathode ribs 7 are beneath the metal framework 101. A high-temperature resisting ceramic sealing material 8 is around the ribs 6 and 7 and between every two ribs to define each membrane electrode, two metal covers 9 and 10 above and below the gas reaction zones 2 and 3 are disposed on both sides of the bipolar plate 1, and the one above the cathode gas reaction zone 2 is the metal cover 9, and the one below the anode gas reaction zone 3 is the metal cover 10, two sides of the metal covers 9 and 10 facing to the two gas reaction zones 2 and 3 have a plurality of gas channel 11, which are provided for guiding reaction gas in the gas reaction zones 2 and 3 to the cell electrodes for reaction and discharging the products and gas produced by the reaction.

The oxygen gas supplied by the fuel cell stack enters into the cathode gas reaction zone 2 from the oxygen gas inlet 41, and the oxygen gas entered into the gas reaction zone 2 is transmitted from the gas channels 11 at the internal side of the metal cover 9 on the cathode gas reaction zone 2 to every part of the cathode electrode. The products and gas produced after the reaction are discharged from the oxygen gas exhaustion opening 42. An opening on the other side of the bipolar plate 1 is the anode hydrogen gas inlet 51, and another opening at the bottom is the anode hydrogen outlet 52. The ribs 6 and 7 in the two gas reaction zones 2 and 3 on both sides of the bipolar plates 1 have a plurality of openings 12, which can be in a rectangular, circular, elliptical or any other geometric shape for allowing the reaction gas to enter into the cell electrodes for the reaction.

In FIG. 1, the protrusions on both left and right sides of the metal covers 9 and 10 are two inter-connecting ends 13, which can be coupled externally to two controllable heat sources for improving the startup problem of the solid oxide fuel cell. With the design of the gas channels 11, the required working temperature of the solid oxide fuel cell can be achieved more uniformly and quickly. Hence, the present invention obviously has the novelty thereof with the comparison to the prior art that purely uses the reaction gas to heat.

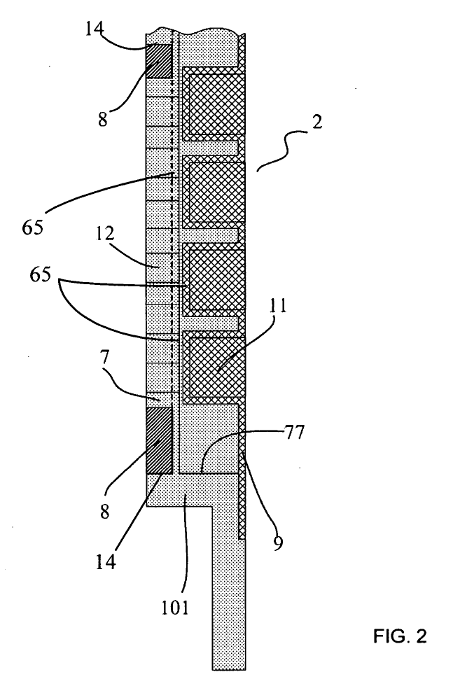

With reference to FIG. 2 for a cross-sectional view of section 21-21 as depicted in FIG. 1. A stamped metal cover 9 with a corrugated shape serves as gas channels 11 above the cathod gas reaction zone 2, the protrusion at the internal side of the metal cover 9 defines a fluid channel in the gas reaction zone 2, the protrusions 65 of the gas channels 11 not connecting to the ribs 7 can force the gas to enter into the electrodes through the holes 12 of the ribs 7 for the reaction, the gas channels 11 allow the reaction gas to be distributed uniformly in the cell electrodes. In this embodiment, each of the protrusions 65 of the gas channels 11 has a rectangular cross section, but other common geometric shapes including circular, triangular, trapezium, etc. can be used instead.

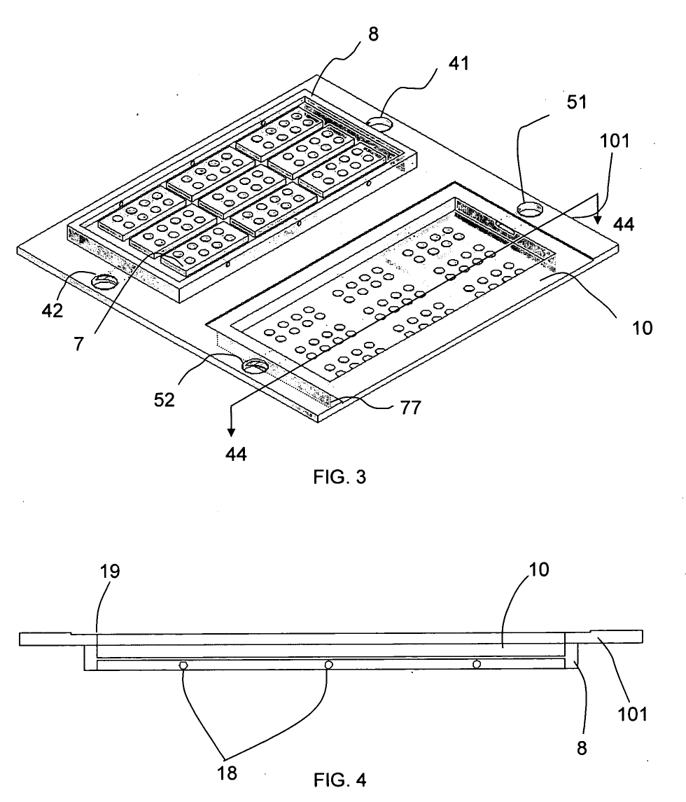

With reference to FIG. 3 for a perspective view of a metal framework 101 of the bipolar plate 1 in accordance with the present invention, the metal cover 10 and the metal framework 101 are combined by a common manufacturing method such as melting soldering. To facilitate the close connection of the metal cover 10 and the metal framework 101, two n-shaped grooves 77 are disposed respectively on both upper and lower surfaces of the metal framework 101 to comply with the dimensions of the metal covers 9 and 10, and such design can combine the metal covers 9 and 10 and the metal framework 101 during the melting soldering process to assure that the two gas reaction zones 2 and 3 are sealed and allows the gas to enter into the inlets 41 and 51 and be discharged from the outlets 42 and 52.

The bipolar plate 1 of the present invention is formed by the stamped metal framework 101 and the ceramic material 8. The middle of the metal framework 101 is stamped in order to have the corrugated shape, and the periphery of the metal framework 101 is with the inlets 41 and 51 and the outlets 42 and 52 for the oxygen and hydrogen comming in and going out and a plurality of horizontal grooves 14, which are to assure a secured connection of both upper and lower sides of the ceramic material 8 and the horizontal grooves 14. The ceramic material 8 and the metal framework 101′ can be combined by the ways of glue molding and compression molding. To conveniently integrate the ceramic material 8 with the metal material of the bipolar plate 1 in the molding process, a plurality of vertical openings 17 are disposed respectively on the upper and lower peripheral portions, wherein the vertical openings 17 can be in the shapes of rectangular, circular, elliptical, and any other geometric shape.

In the bipolar plate of the present invention, the ribs 6 and 7 are wrapped around by the ceramic material 8. Since the external surface of a connecting portion is tightly connected to the electrodes of the fuel cell, the solid oxide electrolyte layer or the electrode coated on the solid oxide electrolyte layer may be damaged easily due to thermal stresses, so that after a metal portion of the bipolar plate 1 is combined with the ceramic material 8, several membrane electrodes with smaller areas can be used to be instead of a membrane electrode with a larger area. Even if the cell breaks down due to an improper operation, an unexpected situation and causing non-uniform thermal stresses, the membrane electrode of the solid oxide fuel cell stack is thus damaged, the present invention can be partially replaced directely. Therefore, with comparison to the prior art of the membrane electrode with a larger area, the present invention obviously has the non-obviousness in the aspect of efficacy.

With reference to FIG. 4 for a cross-sectional view of section 44-44 as depicted in FIG. 3, a plurality of horizontal openings 18 are disposed at a lower peripheral portion of a horizontal groove 19 and have a vertical height difference so as to combine the ceramic material 8 with the horizontal groove 19 closely, and the ceramic material 8 is formed around the ribs 6 and 7, thus the ribs 6 and 7 of the metal framework 101 can be hidden in the ceramic material 8.

In summation of the description above, the present invention forms a bipolar plate by combining a stamped metal sheet and a ceramic material. Such solid oxide fuel cell bipolar plate made of a composite material has the advantages of low-cost, easy-to-make, corrosion resisting, high electric conduction, good heat dissipation, light-weight, and excellent impact-resistant effect. Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

1. A fuel cell bipolar plate, comprising two gas reaction zones and two peripheral zone, wherein the two gas reaction zones are disposed on left and right sides of a metal sheet the fuel cell bipolar plate, one gas reaction zone being on the front surface of the fuel cell bipolar plate, the other gas reaction being on the rear surface of the fuel cell bipolar plate, two stamped metal covers being respectively disposed at the two tops of two recessions of the front and rear surfaces of the fuel cell bipolar plate, two parallel grooves being insulating grooves made by ceramic, a rectangular portion being disposed between the two adjacent insulating grooves having a plurality of ribs used to connect to electrodes, both surfaces of the peripheral zone being planar and having at least one reaction gas inlet and outlet, the bipolar plate being constructed by the two stamped metal covers and the two ceramic insulating grooves, the middles of the two stamped metal covers being formed as two corrugated shapes, each cell being defined by the two ceramic insulating grooves at a contact end of the protrusions on two surfaces of the metal covers.

2. The fuel cell bipolar plate of claim 1, wherein the bipolar plate has two insulating grooves made by ceramic and disposed at protrusions on both sides of the metal sheet.

3. The fuel cell bipolar plate of claim 2, wherein the recession of the two gas reaction zones respectively have a plurality of n-shaped grooves disposed at the upper edges thereof for connecting the metal covers and serving as reserved soldering grooves.

4. The fuel cell bipolar plate of claim 3, wherein the metal covers are disposed above the two gas reaction zones and the protrusions of the stamped metal covers are not connected to the ribs and serve as gas channels in the two gas reaction zones.

5. The fuel cell bipolar plate of claim 1, wherein the ribs have a plurality of openings.

6. The fuel cell bipolar plate of claim 5, wherein the stamped metal sheet has a plurality of vertical openings disposed at the insulating grooves to facilitate filling ceramic into every part of a mold during a molding process.

7. The fuel cell bipolar plate of claim 5, wherein the external periphery of each of the stamped metal covers for connecting a nipple to control a heat source or serving as an electrode nipple.

8. The fuel cell bipolar plate of claim 7, wherein the stamped metal sheet has a plurality of horizontal opening a disposed at the peripheral portion thereof.

9. The fuel cell bipolar plate of claim 1, wherein the recession of the two gas reaction zones respectively have a plurality of n-shaped grooves disposed at the upper edges thereof for connecting the metal covers and serving as reserved soldering grooves.
